(19) United States
(12) Patent Application Publication
(10) Pub. No.: US 2011/0286802 A1
(43) Pub. Date: Nov. 24, 2011

(54) Improved Subsea Riser System

(75) Inventors: Tor Persson, Houston, TX (US); Steven Shu, Houston, TX (US)

(73) Assignee: Jacobs Engineering Group, Pasadena, CA (US)

(21) Appl. No.: 12/785,221

(22) Filed: May 21, 2010

(51) Int. Cl. F16L 1/14

(52) U.S. Cl. 405/170; 405/224.2

(57) ABSTRACT

An improved riser system which comprises a connector for connecting conduits and a mooring system for mooring the connector to the floor of a body of water. The improved riser system also comprises a buoy system for supporting the connector. The buoy system is configured to provide a fixed buoyancy for the connector, the mooring system and at least a portion of the conduits and for providing variable buoyancy for placement of the connector at a predetermined water depth.

### TECHNICAL FIELD

The present invention relates generally to systems for fluid transportation in deepwater environments. Specifically, the present invention relates to a subsea riser system for the transportation of fluids from, for example, a sea floor to a floating vessel or from the floating vessel to the seafloor.

### BACKGROUND OF THE INVENTION

Within various industries, pipes are used to transport fluids from one location to another. In the petroleum industry, for example, pipes are used to transport crude oil from wells to a refinery and gas to a distribution network at least for some distance between the fluid's source and its destination. Proper design of piping systems is important to ensure the transportation of fluids in a safe and environmentally friendly manner. Specifically, a piping system has to be designed so that it maintains its integrity when put in use in its particular application. For example, piping systems for use on land have to be designed to take into account parameters such as the pressure of the fluid being transported, the corrosiveness of the fluid being transported, the environment in which the piping system will be located and seismic activity at the location, to name a few. Designers of piping systems for use in water must contend with such parameters and additional parameters such as hydrostatic pressure (the force exerted by the water due to gravity) and hydrodynamic forces (forces due to the motion of the water).

Hydrostatic and hydrodynamic forces become increasingly more relevant for piping systems as the water depth in which the piping system is installed increases. In the case of offshore petroleum production, pipes, known as risers, extend from the seafloor to equipment for transporting, for example, oil and gas from a wellhead on the sea floor to a surface facility. Risers in deepwater systems are subjected to significant internal and hydrostatic pressure and hydrodynamic forces. Consequently, designing risers to withstand the internal pressures, hydrostatic pressures and hydrodynamic forces of deep-water can be challenging. This challenge is exacerbated when the surface facility to which the riser is connected is a floating platform because movement of the floating platform due to the wave, wind and sea currents can transmit significant stress to the riser. Continuous application of stress to the riser causes fatigue and eventually could rupture the riser.

Close to the surface of a deep body of water, the hydrostatic pressure is low while the hydrodynamic forces are high due to the wind, waves and associated currents. Below the surface currents, there are submerged currents that cause vortex induced vibrations. For example, in the Gulf of Mexico, the surface currents are typically in the first 200 feet of water depth and the submerged currents can exist in about 1000 feet of water depth.

In the deeper zones of the water, the hydrostatic pressure is higher and the hydrodynamic forces lower than the zones close to the surface. Taking into account the different forces existing at different depths, one type of riser system includes a flexible conduit in the upper turbulent zone of the body of water. Because the flexible conduit is limited in its ability to withstand hydrostatic pressures and axial capacity, the flexible conduit is connected to a catenary riser located in the deeper zone of the water (the catenary riser normally curves gently upward from the sea floor). The catenary riser, often made of steel, is able to withstand the hydrostatic pressures at deeper zones of the body of water. The connection between the flexible conduit and the catenary riser is typically located below that zone in the water where the hydrodynamic forces are high. In some riser systems, a buoy is used to support the catenary riser by attaching the riser to the buoy. However, because the flexible conduit is in the upper zone of water, i.e. the first 200 feet of water depth in the Gulf of Mexico, it moves with the currents and this movement causes stress on the catenary riser because the moving flexible conduit is attached to the catenary riser.

What is more, the demands on riser systems are changing, in part, because drilling is increasingly occurring in deeper and more hostile water depth locations. This development has made it more challenging to provide cost effective riser systems because of the corresponding increase in hydrostatic pressure and hydrodynamic forces as riser systems are deployed in deeper and more hostile water depth locations. An additional challenge in designing current riser systems is a need to accommodate subsea systems that permit the size of gas and oil risers to be on the order of 16 inches in diameter and larger. Thus, a need exists for an improved riser system that can address the current demands being placed on riser systems.

### BRIEF SUMMARY OF THE INVENTION

The present invention is directed to an improved riser system and method of installation. Embodiments of the invention reduce the transmission of forces from one portion of the riser system to another through a connector and use a buoy system that provides fixed and variable buoyancy.

One embodiment of the invention includes an improved riser system for use in a deep body of water. The riser system includes two conduits. The first conduit has a first end that is attached to, or is a continuation of, a pipeline located on the sea floor. A connector is connected to the second end of the first conduit. The connector is also connected to a first end of the second conduit and the first and second conduits are coupled together to permit fluid communication between the first and second conduits. The second end of the second conduit is located proximate the surface of the body of water. The connector is configured to reduce transmission of forces from one conduit to the other. The improved riser system includes a mooring system for mooring the connector to the sea floor and a buoy system for supporting the connector, and corresponding portions of the first and second conduits. In embodiments of the invention, the buoy system is attached to the connector and is configured to provide a fixed buoyancy. The buoy system also provides variable buoyancy for adjustment of the buoyancy requirement for the installation method and during the life of the riser. The buoy system is connected to the connector so as to provide vertical support and lateral restraint.

Another embodiment of the invention is a method of installing a riser system in a body of water. The method includes preparing a riser assembly above the surface of the body of water. The preparation of the riser assembly includes connecting a first conduit and a second conduit to a connector so that the first and second conduits are in fluid communication with each other. The preparation of the riser assembly also includes connecting a mooring line to the connector and connecting a buoy system to the connector via a flexible member. When the buoy system is connected to the connector it may be at least partially ballasted. This embodiment of the invention further includes lowering the riser assembly into the body of water to a depth below the surface, and at this point the mooring line is attached to a seabed foundation. While lowering the riser assembly, the first and second conduits can be flooded to provide a slight negative buoyancy, and the mooring line is fixed to the sea floor. After the mooring line is fixed to the sea floor, at least a portion of the buoy system can be deballasted, allowing the connector to stabilize at a second predetermined depth.

The foregoing has outlined rather broadly the features and technical advantages of the present invention in order that the detailed description of the invention that follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the present invention. It will also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of a riser system according to one embodiment of the invention;

FIGS. 2A-2C are illustrations of a connector as it is used in a riser system, according to one embodiment of the invention;

FIGS. 3A and 3B illustrate an installation process for a riser system according to one embodiment of the invention;

FIGS. 4A-4G illustrate an installation process for a riser system according to one embodiment of the invention;

FIG. 5 is an illustration of a buoy according to one embodiment of the invention, and

FIG. 6 is an illustration of a buoy according to one embodiment of the invention.

### DETAILED DESCRIPTION OF THE INVENTION

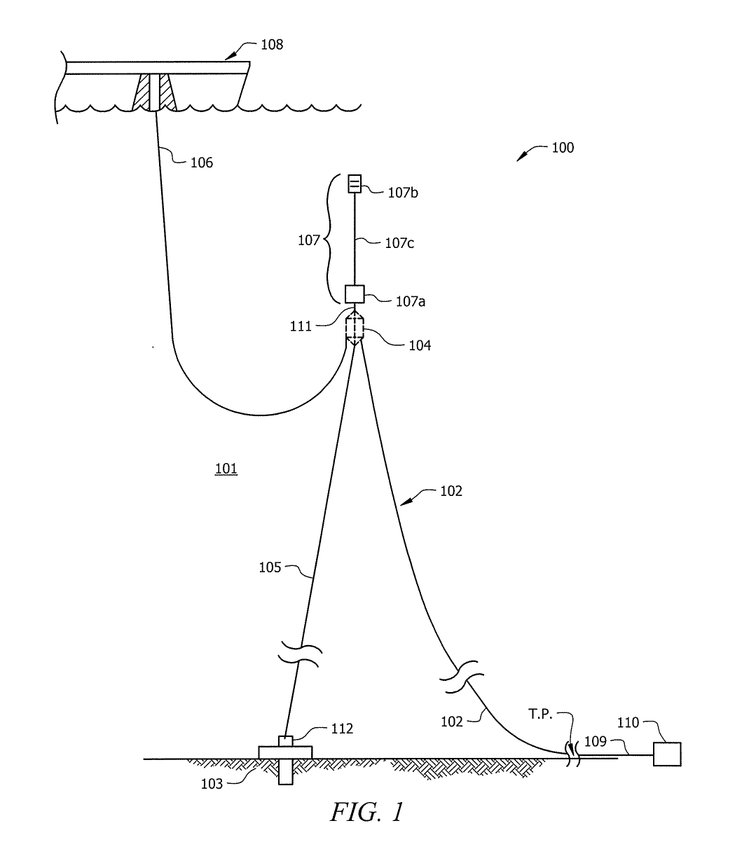

FIG. 1 is an illustration of a riser system according to one embodiment of the invention. Riser system 100 may be for the transportation of oil from a pipeline connected to a wellhead assembly located on seafloor 103 to a floating production, storage and offloading vessel (FPSO) 108. It should be noted that in embodiments of the invention, riser system 100 may be used to transport other types of fluids, such as water and natural gas and to different types of export and surface facilities, such as a floating LNG facility. Moreover, in addition to the transportation of fluids from the seafloor to a surface facility, riser system 100 may transfer fluids from the surface facility to the seafloor, for example, for production enhancement of a seafloor reservoir.

Referring still to FIG. 1, riser system 100 includes two conduits, steel catenary riser (SCR) 102 and flexible conduit 106. In this configuration, SCR 102 is in fluid communication with a pipeline 109 on seafloor 103 that in turn connects to wellhead assembly 110. Further, SCR 102 can be coupled to flexible conduit 106 at connector 104 so that SCR 102 and flexible conduit 106 are in fluid communication. Thus, fluid from the wellhead assembly 110 may flow through pipeline 109, SCR 102, flexible conduit 106 to FPSO 108. SCR 102 and pipeline 109 are able to withstand the hydrostatic pressures in the deeper portions of body of water 101 and may be made of material such as carbon steel and other alloys, the like and combinations thereof.

Flexible conduit 106 is able to withstand the hydrodynamic forces of the upper levels of body of water 101 and, in embodiments of the invention, is designed to be flexible. Flexible conduit 106 may be made of materials such as steel, alloys and synthetic material the like and combinations thereof.

Connector 104, in embodiments of the invention, is configured to reduce the transmission of forces emanating from the movement of flexible conduit 106 to SCR 102. As such, connector 104 can reduce the overall stress and strain to which SCR 102 is exposed over time.

Connector 104 is preferably moored to seafloor 103 by mooring line 105 and a fastening device 112. Fastening device 112 comprises a suction pile, gravity weight, the like or combinations thereof. Mooring line 105 comprises a synthetic fiber tendon. Mooring lines must be able to accommodate high loads. Consequently, mooring lines have traditionally been made from materials such as wire ropes and chains. Over time, however, the development of synthetic fibers has brought about the use of mooring lines made from synthetic tendons. These synthetic fiber tendons have the advantage of being lighter than wire ropes and chains but able to accommodate as high loads as wire ropes and chains do. Therefore, the use of synthetic fiber tendons as mooring lines allows the riser system as a whole to be lighter than when other mooring equipment is used, particularly in the deeper water of current production activity. Mooring line 105 may comprise materials such as Polyester, Aramid (aromatic polyamid), LCAP (Liquid Crystal Aromatic Polyester), the like, and combinations thereof.

Riser system 100 includes buoy system 107 for vertically supporting the submerged weight of connector 104, mooring line 105, flexible conduit 106 and SCR 102. Buoy system 107 can include a variable buoyancy buoy. As such, buoy system 107 may be unitary or may comprise two or more buoys. Accordingly, buoy system 107 may include fixed buoyancy buoy 107A and variable buoyancy buoy 107B. For example, in one embodiment of the invention, variable buoyancy buoy 107B may be positioned at a fixed depth of about 150-200 feet below the surface of body of water 101 and the fixed buoyancy buoy 107A may be positioned at a fixed depth below variable buoyancy buoy 107B. Because buoy system 107 may be capable of providing variable buoyancy, buoy system 107 facilitates the placement of connector 104 at a desired water depth for the attachment of mooring line 105 to fastening device 112, which fastens mooring line 105 to seafloor 103. Additionally, buoy system 107, when connected to connector 104, is preferably configured to provide only vertical support and thereby lateral restraint to connector 104, mooring line 105, flexible conduit 106 and SCR 102. Therefore, by reducing the transmission of forces from flexible conduit 106 to SCR 102, and providing preferably vertical support only to connector 104 by buoy system 107, the service life of SCR 102 may be improved. Connector 104 is preferably connected to flexible member 111 which is connected to fixed buoyancy buoy 107A. In this manner, connector 104 is suspended from buoy system 107. Thus, flexible member 111 provides the vertical support for connector 104 and to some extent laterally restrains connector 104. However, preferably flexible member 111 does not transfer forces from buoy system 107 to SCR 102 and flexible conduit 106 through the connector 104.

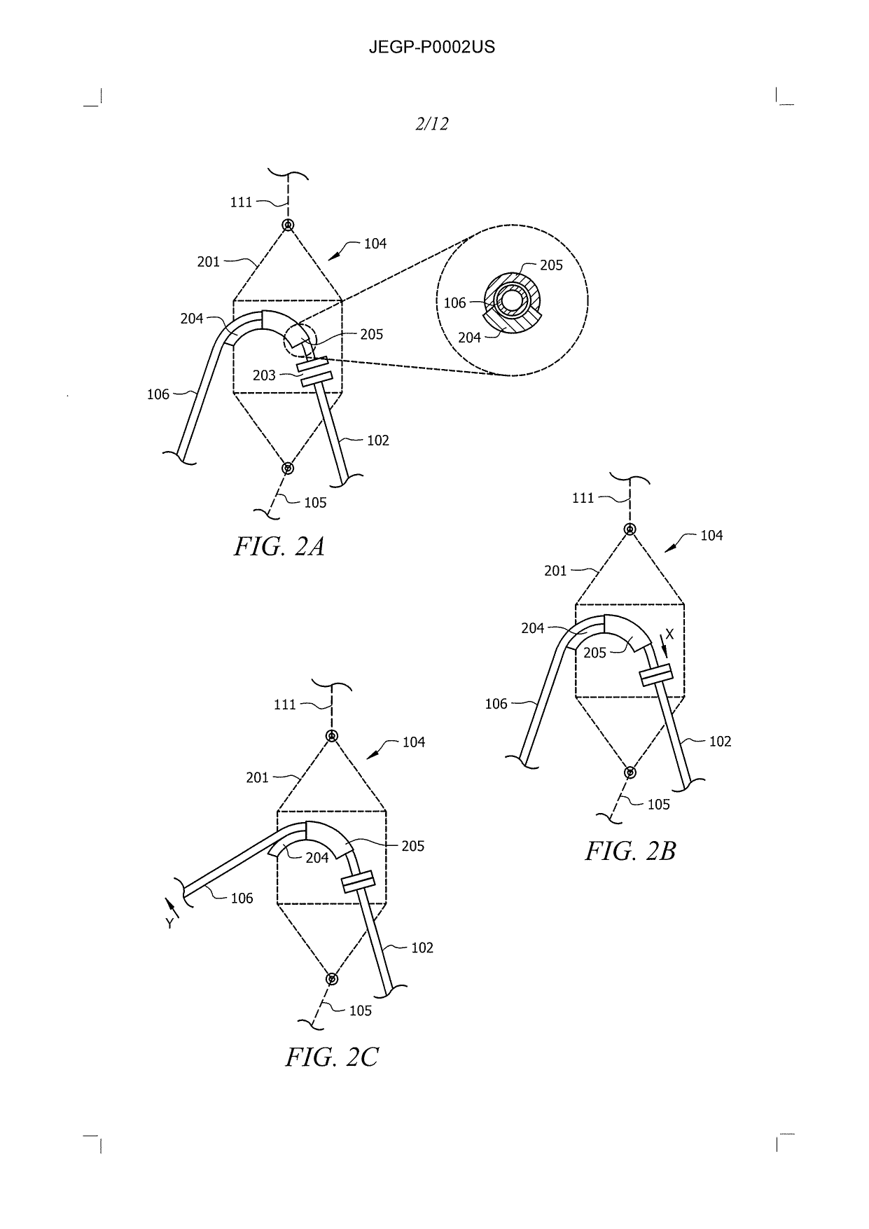

Referring to FIG. 2A, the process for connecting flexible conduit 106 to SCR 102 includes first connecting flexible conduit 106 to connector 104 above the surface of the water. In this embodiment of the invention, flexible conduit 106 is connected to connector 104 by placing flexible conduit 106 on curved support 204. Fastener 205, which may be a circular or loop shape, is used to secure flexible conduit 106 at one end of curved surface 204. Fastener 205 prevents flexible conduit 106 from being dislodged from curved surface 204 but has a large enough diameter to allow flexible conduit 106 to be pulled along curved support 204, as will be described below. After flexible conduit 106 is secured on curved surface 204, connector 104 may be placed in the water. While connector 104 is underwater, SCR 102 may then be pulled into frame assembly 201 using pull lines. After SCR 102 is pulled into frame assembly 201, SCR 102 is locked into frame assembly 201 with a latch mechanism (not shown but well known to those skilled in the art). At this point, there may be gap 203 between SCR 102 and flexible conduit 106.

Referring now to FIG. 2B, to close gap 203 and provide fluid communication between SCR 102 and flexible conduit 106, flexible conduit 106 is pulled down onto SCR 102. Mechanisms known in the art, such as pull lines and hydraulic systems may be used to pull or push flexible conduit 106 onto SCR 102. Once gap 203 is closed, flexible conduit 106 and SCR 102 may be coupled together. In embodiments of the invention, flexible conduit 106 and SCR 102 may be coupled together by a coupling that comprises a Retlock® connector or other such coupling well known to those skilled in the art. In embodiments of the invention, the coupling may comprise the pull-in mechanism for pulling flexible conduit 106 onto SCR 102, (in direction x as shown in FIG. 2B). Further, it should be noted that in a variation of the invention, flexible conduit 106 may first be locked to frame assembly 201, then SCR 102 may be pulled up to and coupled to flexible conduit 106. SCR 102 may then be secured to frame assembly 201. The top portion of frame assembly 201 can be connected to flexible member 111 while the bottom portion of frame assembly 201 is attached to mooring line 105. Referring now to FIG. 2C, this diagram shows how curved support 204 keeps flexible conduit 106 in a bent configuration. Because flexible conduit 106 is in a bent configuration, a force applied to flexible conduit 106 in direction “y”, for example, would bend flexible conduit 106 upwards and pull it away from curved support 204 but not transmit that force to SCR 102. Conversely, a force in the opposite direction of “y” may bend flexible conduit 106 against curved surface 204 but not transmit that force to SCR 102.

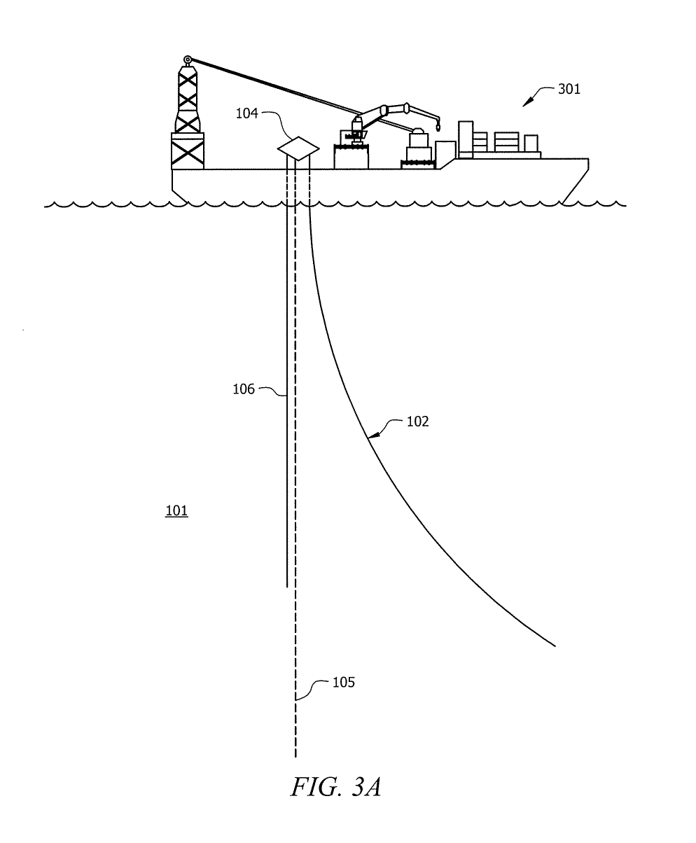

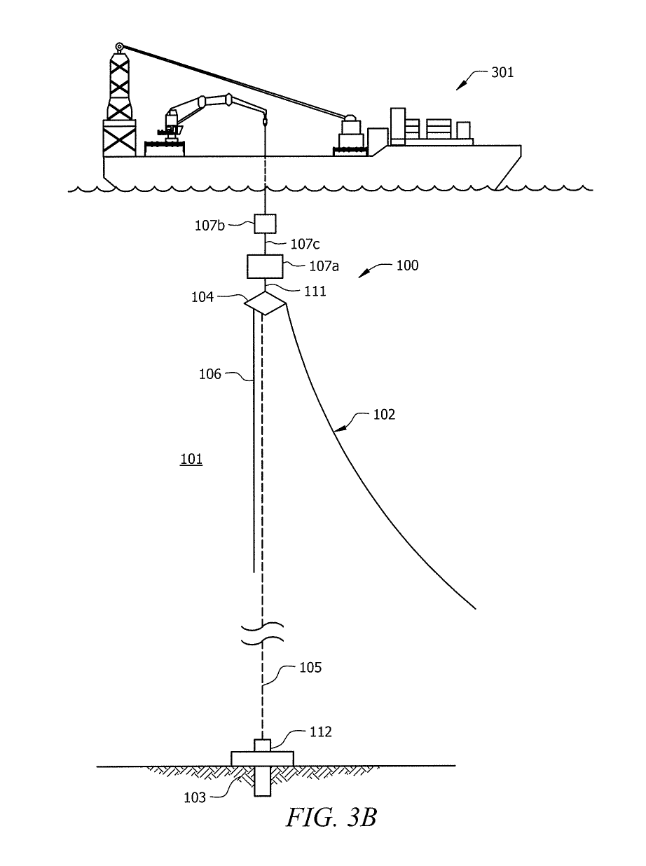

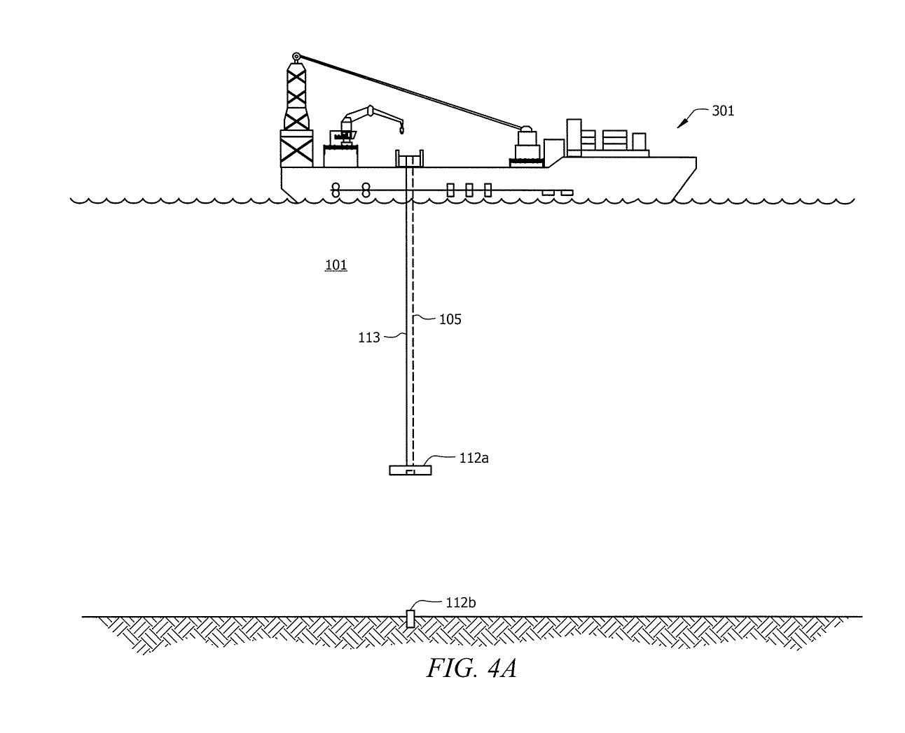

FIGS. 3A and 3B illustrate an installation process for riser system 100 according to one embodiment of the invention. FIG. 3A illustrates an aspect of the installation process that may occur above the surface of the water, for example, on installation vessel 301. To begin the process, mooring line 105 may be cast from installation vessel 301 into body of water 101. Mooring line 105 may be connected to connector 104. Additionally, SCR 102 and flexible conduit 106 may be connected to connector 104 so that SCR 102 and flexible conduit 106 are in fluid communication with each other.

Referring now to FIG. 3B, fixed buoyancy buoy 107A may be connected to connector 104 by flexible member 111. Variable buoyancy buoy 107B may be connected to fixed buoyancy buoy 107A, via flexible member 107C, to form buoy system 107. Fixed buoyancy buoy 107A may be a syntactic foam buoy. Variable buoyancy buoy 107B may be a buoyancy tank in, and from, which water may be pumped to vary its buoyancy. Once fixed buoyancy buoy 107A is connected to connector 104, connector 104, SCR 102, flexible conduit 106 and the remaining portion of mooring line 105 are lowered into body of water 101. Because mooring line 105 comprises synthetic fiber, which is relatively light, fixed buoyancy buoy 107A is able to handle loads in deeper zones of body of water 101, as compared to riser systems that use heavier mooring equipment. SCR 102 and flexible conduit 106 are flooded for the riser system 100 to achieve negative buoyancy when buoy system 107 is placed in body of water 101. It should be noted that although buoy system 107 is shown as having two buoys, in embodiments of the invention, buoy system 107 may comprise more than two buoys.

Referring still to FIG. 3B, in embodiments of the invention, fixed buoyancy buoy 107A is designed to partially support the weight of mooring line 105, connector 104, SCR 102 and flexible conduit 106. In this scenario, the riser system 100 is negative buoyant. To continue the installation operation, flexible member 107C and variable buoyancy buoy 107B may be deployed and allowed to sink to a predetermined depth in body of water 101. Variable buoyancy buoy 107B may be deployed in a fully ballasted or partially ballasted mode so that riser system 100 as a whole still has a negative buoyancy. That is, riser system 100 continues to sink but may be supported from a crane located on installation vessel 301. As riser system 100 sinks, seafloor 103 can support more of the submerged weight of riser system 100 as more of SCR 102 rests on seafloor 103.

When the top of variable buoyancy buoy 107B reaches a desired depth, mooring line 105 may be connected to fastening device 112 which in turn may be fastened to seafloor 103. The connection of mooring line 105 to fastening device 112 may be done with the assistance of a Remote Operated Vehicle (ROV). Indeed, any of the operations disclosed herein, in particular those that take place below the surface of body of water 101, may be done with the assistance of a ROV. In embodiments of the invention, once variable buoyancy buoy 107B is at the desired depth and mooring line 105 is connected to fastening device 112, variable buoyancy buoy 107B is deballasted until it exerts an upward force large enough to counteract the weight of riser system 100 and thereby suspend riser system 100 in body of water 101 at a fixed depth. At this point in this embodiment of the invention, riser system 100 is installed and variable buoyancy buoy 107B is positioned vertically above fixed buoyancy buoy 107A so that buoy system 107 provides only vertical support and lateral restraint to connector 104, mooring line 105, flexible conduit 106 and SCR 102.

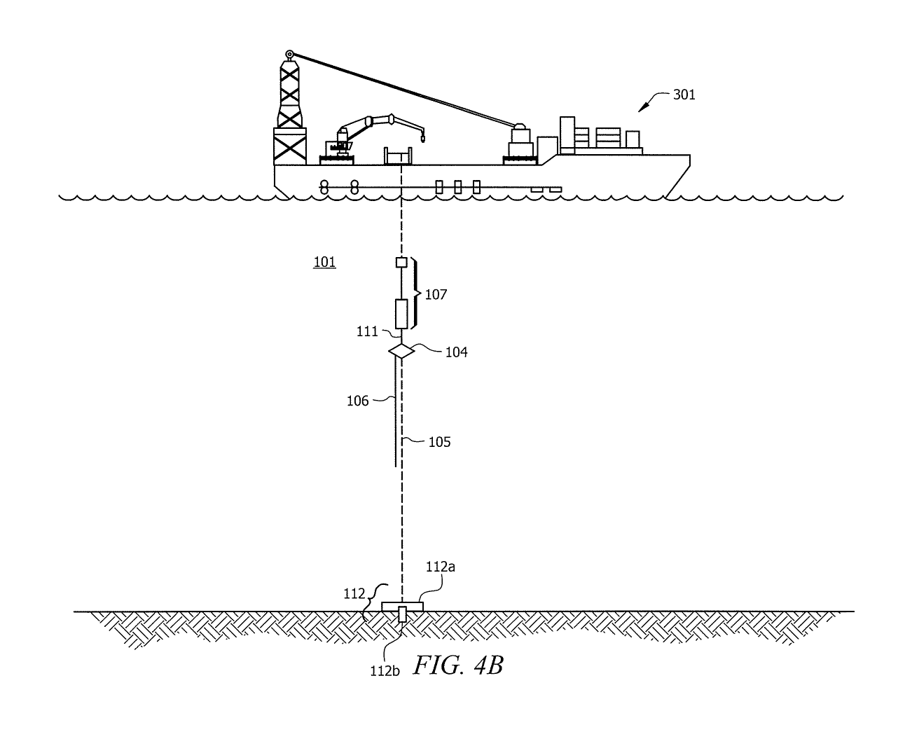

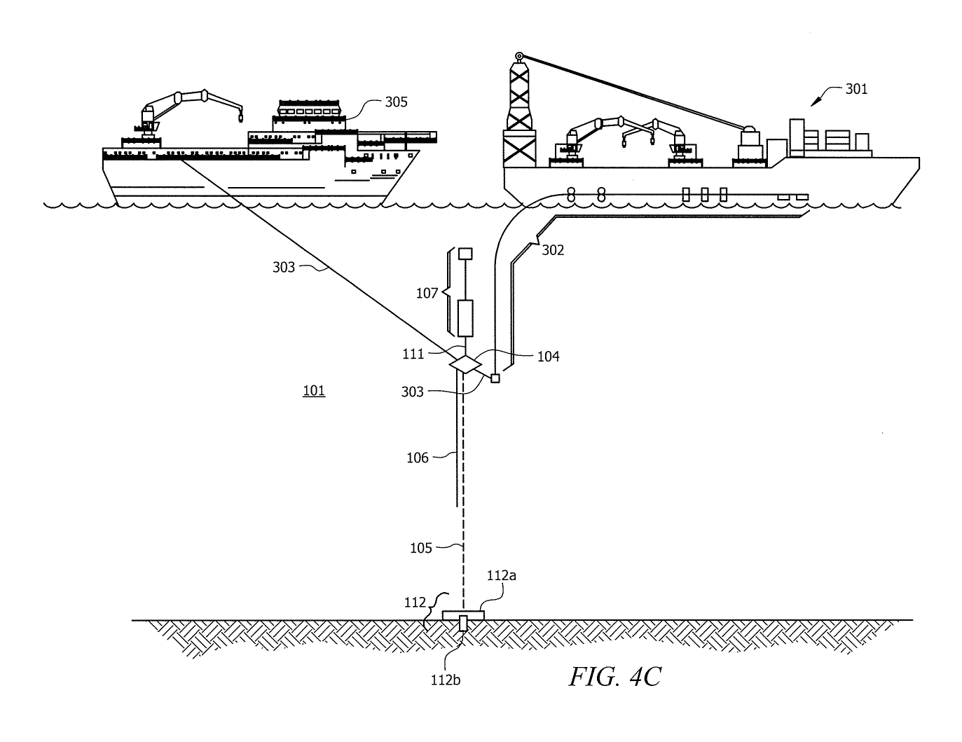

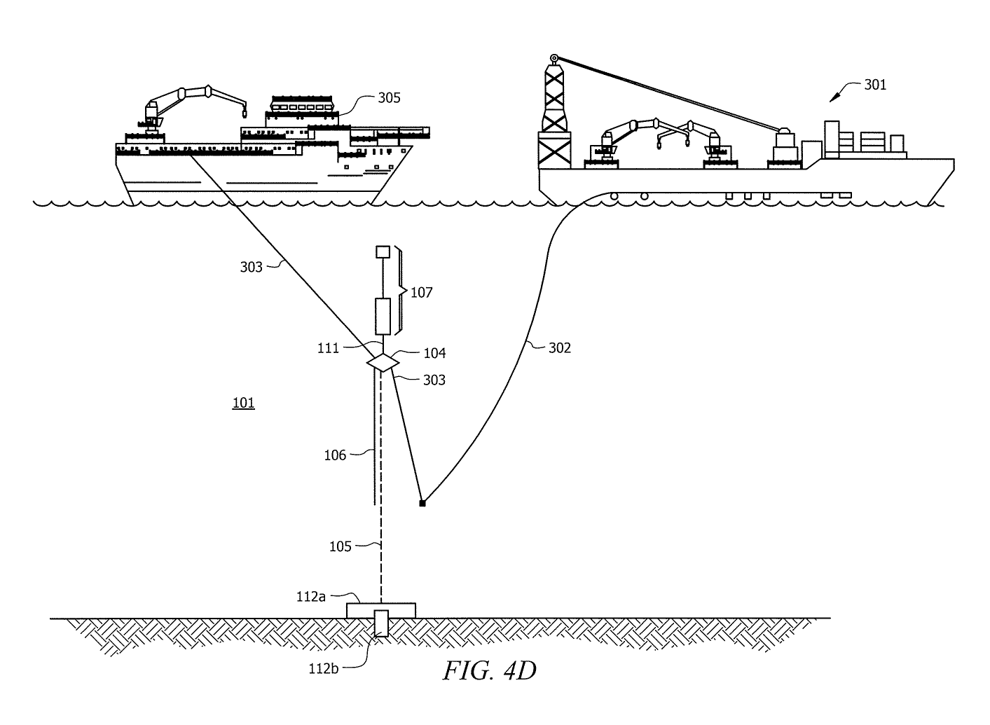

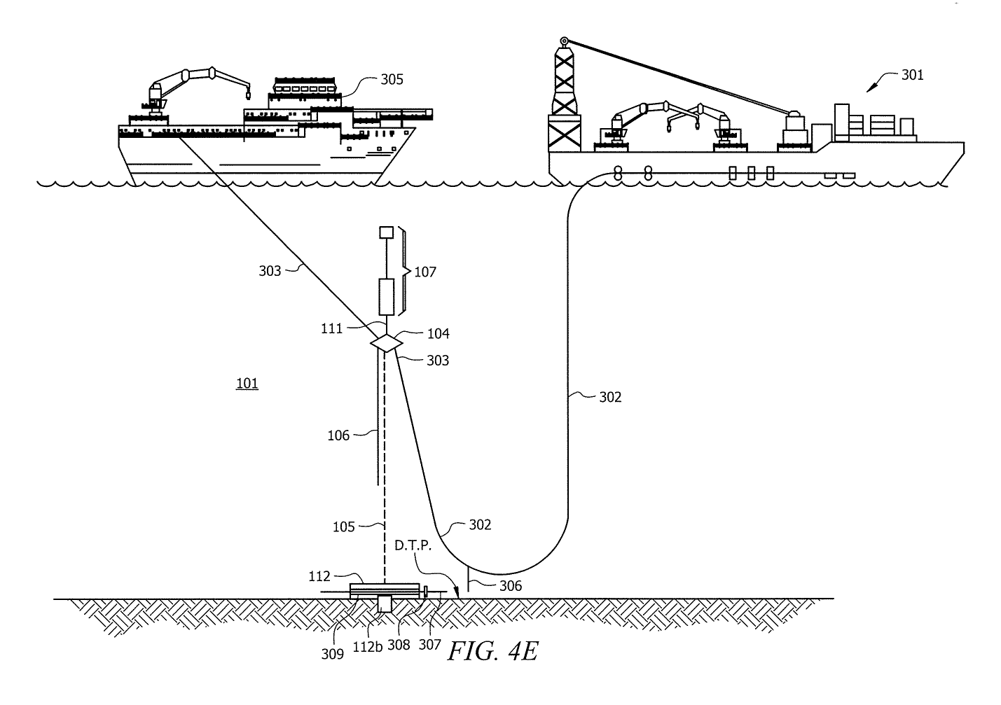

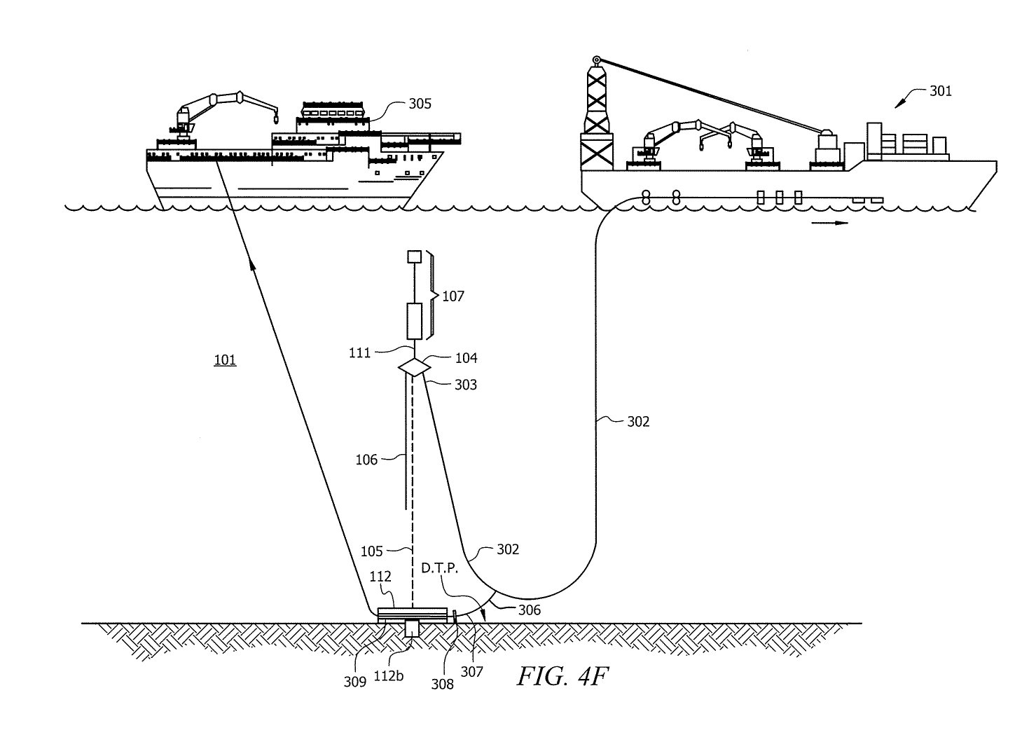

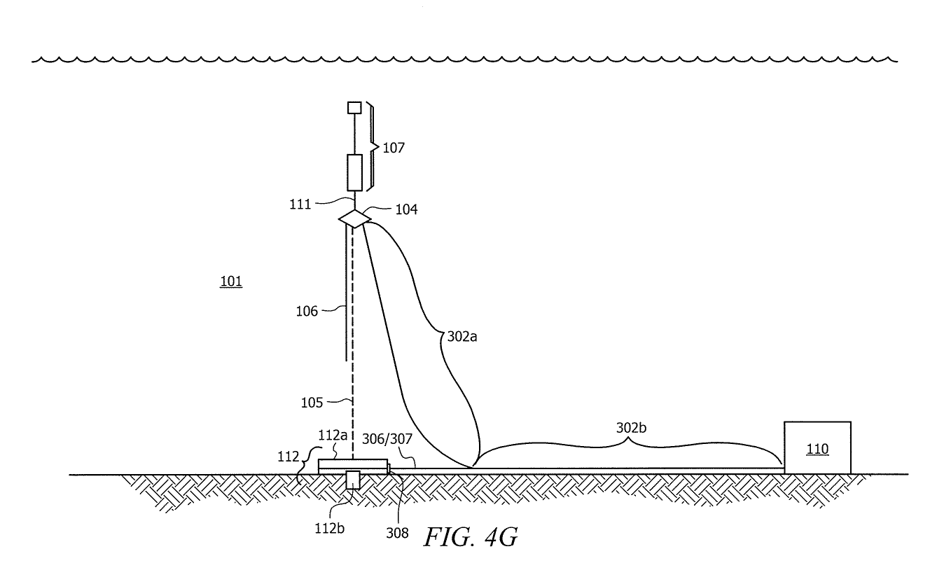

Typically, riser systems are installed by laying a pipeline from an end location, such as a wellhead, to the SCR location with the end of the pipeline furthest from the wellhead forming the SCR. The SCR is usually located proximate to the expected location of the FPSO. However, in instances where the FPSO is already moored at its final location, it may be desirable to install the riser system so that the installation process begins at the riser location and proceeds towards the wellhead. Referring now to FIGS. 4A-4G, embodiments of the invention that may implement this variation of the installation process may include partially assembling the riser system, which may comprise connecting the pipeline to a connector. The preparation of the partial riser assembly includes connecting a mooring line to the connector with a gravity weight suspended from the connector. A buoy system is then connected to a connector via a flexible member, as discussed above in relation to FIGS. 2A-2B. The gravity weight 112 A may then be placed on the seabed onto a suction pile. The magnitude of buoyancy provided by the buoy system may be sufficient to accommodate the weight of the pipeline/SCR when the pipeline/SCR installation begins.

Referring to FIG. 4A, some embodiments of the invention may include a mooring line that comprises synthetic fiber tendons. Mooring lines made from synthetic fiber tendons usually stretch up to 30% of its original length when a load is applied to it. If a mooring line stretches after it is installed in a riser system, that stretching may change the whole configuration of the riser system. To prevent this problem, installation of a riser system that includes mooring lines made from synthetic fiber tendons preferably includes stretching mooring line 105 prior to installing it. The stretching process may begin by attaching gravity weight 112A to lowering line 113 and then lowering gravity weight 112A into the water with the lowering line 113. In other words, lowering line 113 may be used to provide support to, and suspend, gravity weight 112A in body of water 101. One end of mooring line 105 is attached to gravity weight 112A prior to placing gravity weight 112A in body of water 101 and the other end secured to installation vessel 301. By increasing the length of lowering line 113 so that it is longer than mooring line 105 (assuming both lowering line 113 and mooring line 105 are suspended from installation vessel 301 at the same level), the load of gravity weight 112A may be transferred from lowering line 113 to mooring line 105. This transference of load to mooring line 105 may stretch mooring line 105 to a desired length. If the desired length is not at first achieved, the process may be repeated to achieve the desired stretching of mooring line 105.

Referring now to FIG. 4B, after stretching mooring line 105, lowering line 113 is detached from gravity weight 112A and flexible conduit 106, buoy system 107 and mooring line 105 are connected to connector 104 above the surface of the water and then lowered into the water. It should be noted that though buoy system 107 is shown as including fixed buoyancy buoy 107A and variable buoyancy buoy 107B, buoy system 107 could be a composite buoy, as discussed further below.

Referring now to FIG. 4C, the installation of the riser system may include the use of a ramp on installation vessel 301 to assemble pipeline 302 and thus installation vessel 301 may act as a pipe laying vessel. Pipeline 302 may be connected to the riser assembly after the riser assembly has been immersed in body of water 101. In embodiments of the invention, the riser assembly includes a fastening device 112, which may be gravity weight 112A. However, in some situations, for example, when seafloor 103 is sloped, it may be necessary to add suction pile 112B, which provides gravity weight 112A with horizontal stability. In this variation of the invention, gravity weight 112A is lowered onto suction pile 112B.

Referring still to FIG. 4C, after the riser assembly has been placed in body of water 101 at a final predetermined depth, pipeline 302 is payed out into body of water 101. As one end of pipeline 302 reaches the vicinity of connector 104, pipeline 302 is connected to pull lines 303, which in turn runs through connector 104 to winches located on vessel 305. Referring now to FIG. 4D, pull lines 303 can be adjusted in length in order for pipeline 302 to conform to a curvature consistent with a permissible stress level in pipeline 302. Referring now to FIG. 4E, if pull lines 303 are reduced in length by the winches on vessel 305, the end of pipeline 302 will move upward and give pipeline 302 more of a curved configuration.

Referring still to FIG. 4E, installation vessel 301 may continue assembling and paying out pipeline 302 while vessel 305 continues to shorten pull line 303 and thereby pull pipeline 302 towards connector 104. Pull line 303 pulls pipeline 302 into connector 104 and then pipeline 302 is locked onto frame assembly 201 of connector 104. Then pipeline 302 may be connected to flexible conduit 106, similar to the procedure discussed with respect to FIGS. 2A-2B. After pipeline 302 is locked into connector 104 and connected to flexible conduit 106, pull lines 303 may be disconnected from vessel 305 and connector 104. As discussed above with respect to FIGS. 2A-2B, pipeline 302 may be connected to flexible conduit 106 using a coupling suitable for the purpose and this coupling may comprise a Retlock® Connector, which is well known to those skilled in the art. As pipeline 302 is payed out with one of its end locked onto connector 104, pipeline 302 sinks and bends into a catenary configuration.

Referring back to FIG. 1, riser system 100, especially one where the FPSO is in its moored position prior to installation of pipeline 302, may require that the section of pipeline 302 extending from connector 104 touches down or intersects with seafloor 103 at a particular point—a desired touchdown point. To illustrate, this concept, the touchdown point is labeled T.P. in FIG. 1 and the desired touchdown point is labeled DTP in FIGS. 4E and 4F. In embodiments of the invention, a preferred method of achieving the desired touch down point (D.T.P.) is to use connecting lines 306 and 307 to establish the touch down point. Connecting lines 306 and 307 may be made from wire rope. Referring to FIGS. 4E-4F, connecting line 306 may be attached to pipeline 302 and connecting line 307 may extend from and run through channel 309 in fastening device 112.

Referring now to FIG. 4F, as pipeline 302 approaches seafloor 103, connecting line 306 may be joined to one end of connecting line 307 using an ROV. The other end of connecting line 307 may then be pulled through fastening device 112 up to vessel 305. Connecting line 307, in this configuration, may be used as a hauling line by vessel 305 to ensure that the desired touch down point of pipeline 302 is achieved. Specifically, vessel 305 may apply a pulling force on connecting line 307 in one direction. Connecting line 307 may have a stopper 308, which is too large to go through channel 309. The configuration of connecting lines 306 and 307 (including the position of stopper 308) is such that when connecting lines 306 and 307 are joined and stopper 308 rests against gravity weight 112, the touch down point will be the intersection of line 306 with pipeline 302. In other words, the distance of line 306/307 from stopper 308 to the end of line 306/307 that intersects with pipeline 302 determines the desired touch down point.

Referring now to FIG. 4G, pipeline 302 may be installed at one end location, for example, to wellhead assembly 110, and connecting line 306 and 307 may be severed. In its installed position, pipeline 302 comprises SCR 302A and sea floor pipeline 302B. In this configuration, pipeline 302B lies on seafloor 103 and provide fluid communication between wellhead assembly 110 and SCR 302A, which in turn is in fluid communication with flexible conduit 106.

The installed parameters of riser system 100 may vary depending on the body of water in which it is installed and the depth of that body of water. For example, in the Gulf of Mexico, riser system 100 may be installed so that fixed buoyancy buoy 107A is located below submerged currents which typically means greater than 1,000 feet below the surface. Concurrently, the variable buoyancy buoy 107B is located below upper currents and turbulent wave action which typically is about 200 feet below the surface.

As discussed above, embodiments of the invention may include a variable buoy buoyancy and a fixed buoy buoyancy as shown with respect to buoy system 107. The design of buoy system 107 with fixed and variable buoyancy buoys, for installation in riser systems, has several advantages. First, this design makes it easier to install riser systems because it facilitates easy lowering of the riser system at a desired depth. Specifically, the ability to vary the buoyancy provides an ability to change the depth of installation. Second, this variable buoy system provides the ability to select preferred weight requirements. In other words, fixed buoyancy buoy 107A may be selected such that it is still at a slight negative buoyancy at the final operating depth (approximately 1,500 feet in the Gulf of Mexico). Third, in the event variable buoyancy buoy 107B looses buoyancy and sinks, fixed buoyancy buoy 107A may still provide a positive vertical load to support riser system 100 after it sinks marginally, at which point it will reach an equilibrium state (remain suspended). Equilibrium is achieved within body of water 101 because as riser system 100 sinks, some of the weight of SCR 102 will be supported on seafloor 103 rather than by buoy system 107. Fourth, the installation process as disclosed may be easily reversible and thereby facilitates repairs that may be performed above the surface of the water. Specifically, the buoyancy applied to the riser system may be varied and thus after installation, the upward force from the buoy system may be increased to allow the riser system to ascend and be easily removed from the water.

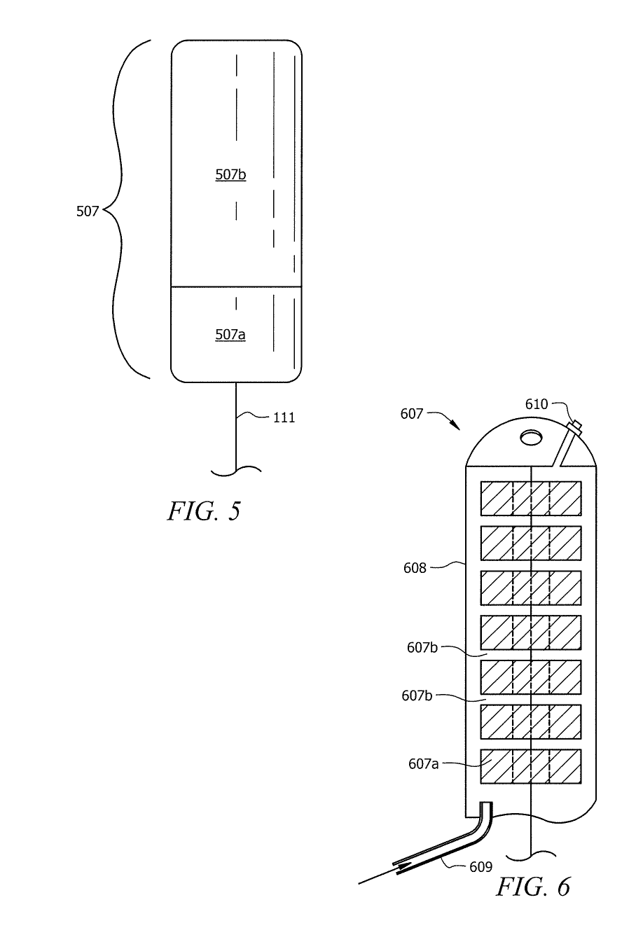

Referring to FIG. 5, one embodiment of the invention includes composite buoy 507. Composite buoy 507 comprises fixed buoyancy portion 507A and variable buoyancy portion 507B. Fixed buoyancy portion 507A may comprise syntactic foam or other material providing a constant or fixed vertical load. Variable buoyancy portion 507B may comprise a tank, to and from, which water may be pumped or any other configuration for providing variable buoyancy. The configuration of composite buoy 507 may be preferred in selected water depths, particularly if it is desirable to locate the sources of the fixed buoyancy and the variable buoyancy below anticipated upper and loop currents.

Referring now to FIG. 6, one embodiment of the invention includes buoy 607. Buoy 607 comprises housing 608. Housing 608 encloses syntactic foam buoy elements 607A, which are separate elements and may be separated by voids 607B. When syntactic buoy 607 is deployed in water, its buoyancy effect may be increased by passing a gas, such as air, through, for example, pipe 609. Conversely, buoy 607's buoyancy may be decreased by releasing gas from housing 608 through valve 610.

In embodiments of the invention, mooring line 105 includes several tendons, which may include synthetic fiber tendons. If one or more tendons break, in this configuration, an unbroken tendon could still maintain the installation in the desired location. Referring again to FIG. 1, if all the tendons break, fixed buoyancy buoy 107A will rise to the surface of body of water 101 or rise to a higher level that is below the surface as it moves into an equilibrium state when the weight of the SCR 102 and pipeline 109 increases (because they are less supported by seafloor 103) to a point when the upward force from buoy system 107 equals the downward force from the weight of SCR 102 and pipeline 109. That is, riser system 100 becomes suspended closer to the surface. In sum, failure of the components of riser systems comprising embodiments of the current disclosure will not cause a catastrophic failure of the whole riser system.

Riser systems according to embodiments of the invention may include several combinations of SCR 102, connector 104 and flexible conduit 106. For example, a first combination of SCR 102, connector 104 and flexible conduit 106 may connect a first wellhead assembly to a manifold assembly on FPSO 108. Concurrently, a second combination of SCR 102, connector 104 and flexible conduit 106 may connect a second wellhead assembly to the same manifold assembly on FPSO 108. Other configurations may also include different combinations of SCR 102, connector 104 and flexible conduit 106 running from the same well head to the manifold on FPSO 108. As one skilled in the art would recognize, such combinations are within the scope of the current invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An improved riser system for use in a body of water, said system comprising:
a first conduit having a first and second end, said first end interfacing the floor of the body of water;
a connector connected to said second end of said first conduit;
a mooring system for mooring said connector to the floor of the body of water;
a second conduit having a first and second end, said connector connected to the first end of said second conduit, said first and second conduits being coupled together and in fluid communication with each other; and
a buoy system for supporting said connector, said buoy system configured to provide a fixed buoyancy force for said connector, said mooring system and at least a portion of said first and second conduits, and for providing a variable buoyancy force for placement of said connector at a predetermined water depth.

2. The system of claim 1 wherein said buoy system comprises at least a first and second buoy.

3. The system of claim 2 wherein said first buoy provides said fixed buoyancy force.

4. The system of claim 2 wherein said second buoy provides said variable buoyancy force.

5. The system of claim 1 wherein said buoy system comprises a buoy having a portion providing fixed buoyancy and a portion providing variable buoyancy.

6. The system of claim 1 wherein said mooring system comprises a tendon made from synthetic fiber.

7. The system of claim 1 wherein said buoy system is connected to said connector so as to provide only vertical support and lateral restraint.

8. An improved riser system for use in a body of water, said system comprising:
a first conduit having a first and second end, said first end interfacing the floor of the body of water;
a connector connected to said second end of said first conduit;
a mooring system for mooring said connector to the floor of the body of water;
a second conduit having a first and second end, said connector connected to the first end of said second conduit, said first and second conduits being coupled together and in fluid communication with each other; and
a buoy system for supporting said connector, said buoy system having first and second buoyancy assemblies, said first buoyancy assembly providing a fixed buoyancy force for said connector, said mooring system and at least a portion of said first and second conduits, and said second buoyancy assembly providing a variable buoyancy force for placement of said connector at a predetermined water depth, said buoy system connected to said connector so as to provide only vertical support and lateral restraint.

9. The system of claim 8 wherein said mooring system comprises a tendon made from synthetic fiber.

10. An improved riser system for use in a body of water, said system comprising:
a first conduit having a first and second end, said first end interfacing the floor of the body of water;
a connector connected to said second end of said first conduit;
a mooring system for mooring said connector to the floor of the body of water;
a second conduit having a first and second end, said connector connected to the first end of said second conduit, said first and second conduits being coupled together and in fluid communication with each other; and
a buoy system for supporting said connector, said buoy system configured to provide a fixed buoyancy force for said connector, said mooring system and at least a portion of said first and second conduits, and for providing a variable buoyancy force for placement of said connector at a predetermined water depth, said buoy system connected to said connector so as to provide only vertical support and lateral restraint, wherein said buoy system comprises a buoy having a portion providing the fixed buoyancy force and a portion providing the variable buoyancy force.

11. The system of claim 10 wherein said mooring system comprises a tendon made from synthetic fiber.

12. An improved riser system for use in a body of water, said system comprising:
a first conduit having a first and second end, said first end interfacing the floor of the body of water;
a connector connected to said second end of said first conduit, wherein said connector is located about 1400 to 1600 feet below the surface of said water;
a mooring system for mooring said connector to the floor of the body of water;
a second conduit having a first and second end, said connector connected to the first end of said second conduit, said first and second conduits being coupled together and in fluid communication with each other, and
a buoy system for supporting said connector, said buoy system having a first buoy and a second buoy so that said first buoy provides fixed buoyancy for said connector, said mooring system and at least a portion of said first and second conduits and said second buoy provides variable buoyancy for placement of said connector at a predetermined water depth, said buoy system connected to said connector so as to provide only vertical support and lateral restraint, wherein said first buoy located about 15 to 20 feet above said connector and said second buoy located about 1200 to 1300 feet above said first buoy.

13. A method of installing a riser system in a body of water, said method comprising the steps of:
positioning a first conduit having a first and second end so that the first end interfaces the floor of the body of water;
connecting a connector to the second end of the first conduit;
mooring the connector to the floor of the body of water;
connecting a first end of a second conduit to the connector;
coupling the second end of the first conduit to the first end of the second conduit so that the conduits are in fluid communication with each other, wherein a second end of the second conduit is proximate the surface of the body of water; and
supporting the connector with a buoy system configured to provide a fixed buoyancy force and a variable buoyancy force.

14. The method of claim 13 further comprising the step of lowering the buoy system to a first predetermined depth.

15. The method of claim 14 further comprising the step of deballasting said buoy system to vary the buoyancy force and position the buoy system at a fixed predetermined depth.

16. A method of installing a riser system in a body of water, said method comprising the steps of:
positioning a first conduit having a first and second end so that the first end interfaces the floor of the body of water;
connecting a connector to the second end of the first conduit;
mooring the connector to the floor of the body of water;
connecting a first end of a second conduit to the connector;
coupling the second end of the first conduit to the first end of the second conduit so that the conduits are in fluid communication with each other, wherein a second end of the second conduit is proximate the surface of the body of water;
supporting the connector with a buoy system configured to provide a fixed buoyancy and to provide variable buoyancy;
lowering the buoy system to a first predetermined depth; and
deballasting said buoy system to vary the buoyancy force and position the buoy system at a final predetermined depth.

17. A method of installing a riser system in a body of water, said method comprising:
preparing a riser assembly above the surface of the body of water, wherein said preparation comprises:
connecting a flexible conduit to a connector,
connecting one end of a mooring line to the connector,
connecting a flexible member between a buoy system and the connector, and
connecting a gravity weight to the other end of the mooring line;
lowering the riser assembly into the body of water to a predetermined depth below the surface of the body of water;
placing the gravity weight on the floor of the body of water;
assembling a pipeline at or above the surface of the body of water; and
paying out the pipeline into the body of water.

18. The method of claim 17 wherein the mooring line comprises tendon made from synthetic fiber.

19. The method of claim 17 further comprising connecting a pull-in line between the pipeline and the connector.

20. The method of claim 19 further comprising pulling the pipeline towards the connector using the pull-in line.

21. The method of claim 20 further comprising connecting the pipeline to the connector.

22. The method of claim 21 further comprising pulling the flexible conduit onto the pipeline and coupling the flexible conduit and pipeline together so that the flexible conduit and pipeline are in fluid communication.

23. The method of claim 20 further comprising allowing the pipeline to sink to the floor of the body of water, bend and form a catenary riser.

24. The method of claim 17 further comprising the step of, prior to connecting the mooring line to the gravity weight, connecting the gravity weight to a lowering line and then suspending the gravity weight with the lowering line in the body of water.

25. The method of claim 24 further comprising, after connecting the mooring line, increasing the length of the lowering line so as to transfer the weight of the gravity weight from the lowering line to the mooring line in order to stretch the mooring line.

26. The method of claim 17 further comprising connecting a first connecting line to the pipeline and connecting a second connecting line to the gravity weight, wherein the combined length of the connecting lines is a function of a preferred initial point of contact of the pipeline with the floor of the body of water.

27. The method of claim 26 further comprising connecting the first and second connecting lines and pulling on one end of the second line to a predetermined point to effect the preferable initial point of contact of the pipeline with the floor of the body of water.
